(19) United States
(12) Patent Application Publication
(10) Pub. No.: US 2023/0376707 A1
(43) Pub. Date: Nov. 23, 2023

(54) High-Speed Hard Drive Bender Mechanism for Destroying the Functionality of Hard Drive Data Bearing Components

(71) Applicant: Sepehr Rajaie, Pataskala, OH (US)

(72) Inventor: Sepehr Rajaie, Pataskala, OH (US)

(21) Appl. No.: 17/748,486

(22) Filed: May 19, 2022

(51) Int. Cl. G06K 7/10; G06K 7/14

(52) U.S. Cl. CPC G06K 7/10366; G06K 7/1413

(57) ABSTRACT

The present invention is This High-Speed Hard Drive Bender Mechanism which provides reconciliation and tracking with a unique identification tag using a secure and proprietary database, processing to destroy the functionality of the data bearing components of magnetic hard drive data bearing devices using a High-Speed Hard Drive Bender Mechanism, and containment of the remains of magnetic hard drive devices for verification.

### CROSS-REFERENCES TO RELATED APPLICATIONS (IF ANY)

Not Applicable

### BACKGROUND

### 1. Field of the Invention

The present invention relates to a High-Speed Hard Drive Bender Mechanism for Destroying the Functionality of Hard Drive Data Bearing Components.

### 2. Description of Prior Art

Magnetic hard drive data bearing devices that eventually fail or are decommissioned are separated from the host server or array or other computer device and need to have the functionality of the data bearing components destroyed so that the data is no longer usable. The NSA data destruction process for magnetic hard drives includes first and second phases and must be verified to meet cybersecurity framework regulations.

Other systems may not track devices during the data destruction process. Other systems may not destroy the functionality of data bearing components on magnetic hard drive data bearing devices. Other systems may not be intended for use with magnetic hard drive data bearing devices that have had changes in their characteristics. Other systems may not perform the data destruction for magnetic hard drives in a time saving manner. Other systems may require frequent maintenance, leading to down time. Other systems may not be portable. Other systems may not be used within an organization's secure location. Other systems may process data bearing devices in a location that is outside the secure confines of a data center or enterprise facility which constitutes a security risk. Other systems may not be changeable based on changes in the characteristics of magnetic hard drive products. Other systems may not be changeable to meet changes made to cybersecurity framework regulations. Other systems may not have a window on the machine to monitor the bending process. Other systems may not have the double bend on the hard drive platter.

There is still room for improvement in the art.

### SUMMARY OF THE INVENTION

The present invention is a High-Speed Hard Drive Bender Mechanism which provides reconciliation and tracking with a unique identification tag using a secure and proprietary database, processing to destroy the functionality of the data bearing components of magnetic hard drive data bearing devices using a High-Speed Hard Drive Bender Mechanism, and containment of the remains of magnetic hard drive devices for verification.

Also, this High-Speed Hard Drive Bender Mechanism can be produced to allow for transportation to and use of the mechanism within the organization's secure locations (datacenter or enterprise facility). This High-Speed Hard Drive Bender Mechanism can be produced to process magnetic hard drive devices in a time saving manner and reducing down time for maintenance. The components of this High-Speed Hard Drive Bender Mechanism are modular and can be changed based on changes in the characteristics of magnetic hard drive products and changes in the cybersecurity framework regulations for data destruction. This High-Speed Hard Drive Bender is used in the second phase of NSA data destruction process and keeps pace with the High-Speed NSA certified degausser used in the first phase. This mechanism has a high strength window so the user can safely monitor the bending process. This mechanism has a double bend on the hard drive platter.

It is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a flowchart of the invention; and

FIG. 2 shows a diagram of some of the components of the invention.

### DESCRIPTION OF THE PREFERRED EMBODIMENT

There are a number of significant design features and improvements incorporated within the invention.

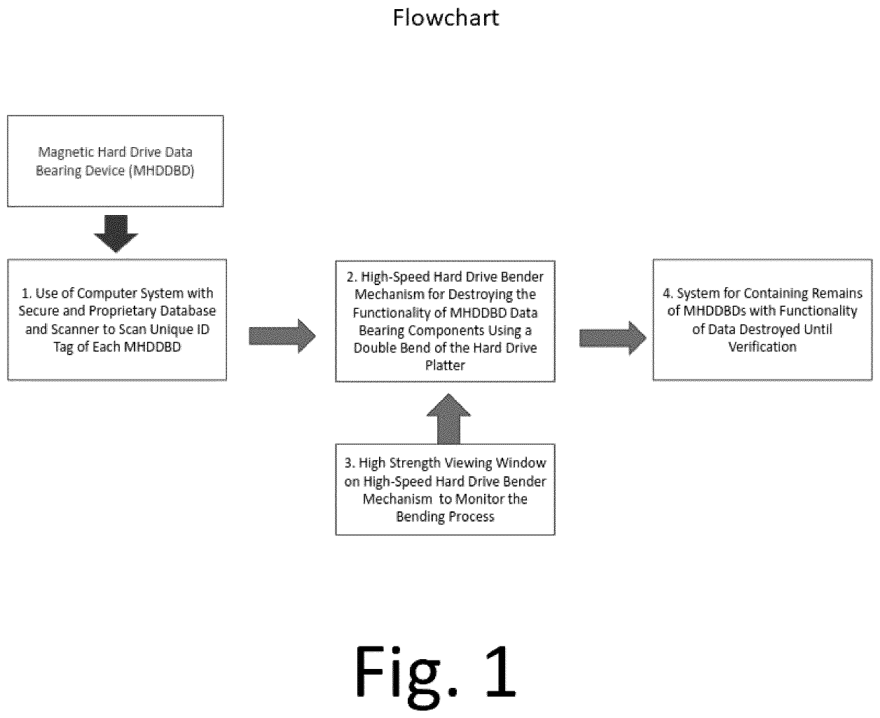

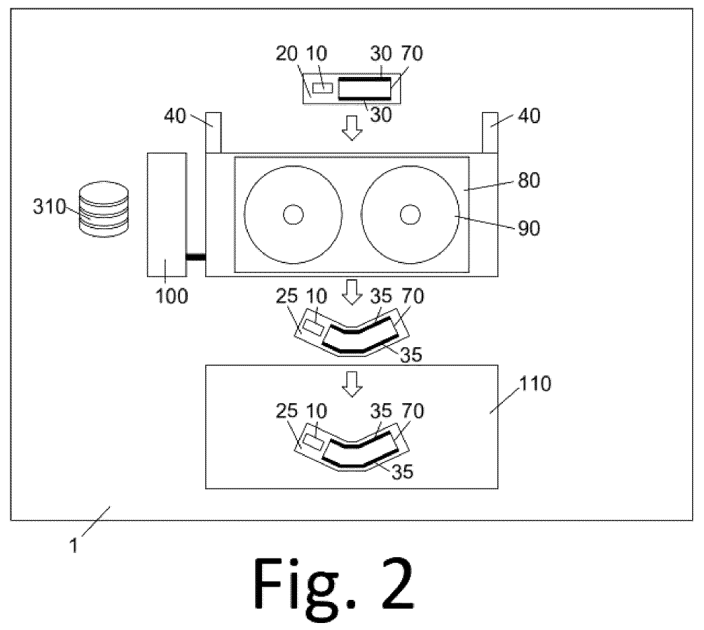

As shown in FIGS. 1 and 2, the present invention is a High-Speed Hard Drive Bender Mechanism 1 for Destroying the Functionality of Hard Drive Data Bearing Components 30.

Magnetic hard drive data bearing devices 20 that eventually fail or are decommissioned are separated from the host server or array or other computer device and need to have the functionality of the data bearing components 30 destroyed so that the data is no longer usable. The NSA data destruction process for magnetic hard drive data bearing devices 20 includes first and second phases and must be verified to meet cybersecurity framework regulations. This mechanism 1 meets the second phase requirements of the NSA data destruction process for magnetic hard drive data bearing devices 20.

This High-Speed Hard Drive Bender Mechanism 1 provides reconciliation and tracking with a unique Radio Frequency Identification (“RFID”) or bar codes or PID or active unique identification tag 10 using a secure and proprietary database 310 located on non-transitory memory 100, processing to destroy the functionality of the data bearing components 30 of magnetic hard drive data bearing devices 20 using a bender mechanism 90, and providing containment in a container 110 of the remains of magnetic hard drive devices 25 for verification.

This High-Speed Hard Drive Bender Mechanism 1 is portable and is intended for use within the organization's secure confines (datacenter or enterprise facility). All of the components of this High-Speed Hard Drive Bender Mechanism 1 are modular and can be changed based on changes in the characteristics of magnetic hard drive products and changes in the cybersecurity framework regulations for data destruction. This High-Speed Hard Drive Bender Mechanism 1 is used in the second phase of NSA data destruction process and keeps pace with the High-Speed NSA certified degausser used in the first phase. This mechanism 1 is contained within a structure that has a high strength window 80 so the user can safely monitor the bending process. This mechanism 1 has a bender mechanism 90 which performs a double bend on the hard drive platter 70.

This High-Speed Hard Drive Bender Mechanism 1 can be produced to allow for transportation to and use of the mechanism within the organization's secure locations (datacenter or enterprise facility). This High-Speed Hard Drive Bender Mechanism 1 can be produced to process magnetic hard drive data bearing devices 20 in a time saving manner and reducing down time for maintenance.

The process is shown in the following steps. Step 1 is when the magnetic hard drive data bearing device 20 has its unique identification tag 10 entered into the database 310 using readers/scanners 40. Step 2 is the destroying of the functionality of the data bearing components 30 on the magnetic hard drive data bearing device 20 within the High-Speed Hard Drive Bender Mechanism 1 using bender mechanism 90 for double bending the hard drive platter 70. Step 3 is the monitoring of the bending process using a high strength window 80. Step 4 is the system for containing the remains of magnetic hard drives 25 with functionality of the destroyed data bearing components 35 in a container 110 for the means of verification that the functionality of the data bearing components has been destroyed.

In the preferred embodiment, the High-Speed Hard Drive Bender Mechanism 1 is used by an organization which uses it to have external certification such as a formal Cyber Security Framework (CSF) that requires verification that the magnetic hard drive data bearing devices 20 that currently hold data 30 or at one time held data 30 have the functionality of the destroyed data bearing components 35.

The High-Speed Hard Drive Bender Mechanism 1 has a secure database 310 in non-transitory memory 100 to hold information to verify that the data on magnetic hard drive data bearing devices 20 that currently hold data 30 or at one time held data 30 have the functionality of their destroyed data bearing components 35.

Unique identification tags 10 are used to label the magnetic hard drive data bearing devices 20 and to correlate with information on the magnetic hard drive data bearing device 20 on the secured database 310. This High-Speed Hard Drive Bender Mechanism 1 requires a reader/scanner 40 to scan the unique identification tag 10 and record this into the secure database 310 stored in non-transitory memory 100 before a magnetic hard drive data bearing device 20 that currently holds data 30 or at one time held data 30 is inserted into the High-Speed Hard Drive Bender Mechanism 1. This High-Speed Hard Drive Bender Mechanism 1 requires a magnetic hard drive data bearing device 20 to first go into an NSA certified degausser for degaussing as the first phase to destroy the data 30.

The High-Speed Hard Drive Bender Mechanism 1 requires the magnetic hard drive data bearing device 20 to be inserted into the High-Speed Hard Drive Bender Mechanism 1 for phase two of destruction. The High-Speed Hard Drive Bender Mechanism 1 activates to destroy the functionality of the magnetic hard drive data bearing device 20 by double bending the hard drive platter 70. The High-Speed Hard Drive Bender Mechanism 1 requires a high strength window 80 so the bending process can be safely monitored. The High-Speed Hard Drive Bender Mechanism 1 has a collection system of a container 110 to securely contain the remains of the magnetic hard drive data bearing devices 25 with the functionality of the destroyed data bearing components 35 for the means of verification that the data has been destroyed.

The use of the High-Speed Hard Drive Bender Mechanism 1 could be followed immediately by verification to limit that amount of time and space needed for secure containment. The use of the High-Speed Hard Drive Bender Mechanism 1 could be used with an inventory system that has the information about the magnetic hard drive data bearing device 20 that currently holds data 30 or at one time held data 30 already enrolled into the secure database 310.

The magnetic hard drive data bearing devices 20 that have been determined as ready for decommissioning and are removed from the host server or array or other computer device can be reconciled and tracked with a unique identification tag 10 using a secure and proprietary database 310-and stored securely in non-transitory memory 100 and stored securely prior to use of the High-Speed Hard Drive Bender Mechanism 1.

### Advantages

By following the High-Speed Hard Drive Bender Mechanism's process, the organization can be confident that the functionality of the data bearing components of the magnetic hard drive data bearing devices has been destroyed. This alleviates the potential problem of the organization damaging their brand due to leaks of secure data onto the global network. It helps solve the insider threat in cybersecurity. It saves the organization time and effort in marketing and answering claims in the legal system regarding secure data breaches. It helps the organization meet cybersecurity regulations and avoid significant fines for non-compliance.

Additionally, the High-Speed Hard Drive Bender Mechanism can be used to double deform other types of devices onsite and in the organization's control that are not magnetic rendering them nonfunctional. The device has a high strength window to allow the user to safely monitor the double bending process. Also, it can create a new method to destroy the functionality of data on magnetic hard drive data bearing devices, and a new time saving method to destroy the functionality of data on magnetic hard drive data bearing devices.

### Conclusion

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A device of destroying the functionality of hard drive data bearing components:
a portable mechanism having a window where the mechanism has modular components that receives hard drive data bearing devices that are tagged, scanning the tag using a scanning means, and having a bender mechanism perform a double bend on the hard drive platter for destruction of the functionality of the data bearing components of hard drive data bearing devices.

2. The device according to claim 1 using computer system.

3. The device according to claim 1 using a scanner.

4. (canceled)

5. The device according to claim 1 having a collection system.

6. (canceled)

7. A process to destroy the functionality of hard drive data bearing components comprising;
tagging a hard drive data bearing device,
scanning the tag using a scanning means;
having a portable mechanism having a window where the mechanism has modular components that receives hard drive data bearing devices
activating to destroy the functionality of the data bearing components of the hard drive data bearing device by having a bending mechanism double bending the hard drive platter and
containment of the remains of the magnetic hard drive devices for the means of verification that the data has been destroyed.

8. The system according to claim 7 using computer system.

9. The system according to claim 7 using a scanner.

10. (canceled)

11. The system according to claim 7 having a collection system.

12. (canceled)
